(19) United States
(12) Patent Application Publication
(10) Pub. No.: US 2018/0089699 A1
(43) Pub. Date: Mar. 29, 2018

(54) SYSTEMS AND METHODS FOR MANAGING A USER EXPERIENCE FOR CONSUMER PRODUCTS

(71) Applicant: Sphero, Inc., Boulder, CO (US)

(72) Inventors: Damon Arniotes, Lafayette, CO (US); Ian Bernstein, Boulder, CO (US); David Hygh, Broomfield, CO (US); Jonathan Carroll, Boulder, CO (US); Kevin Menzie, Superior, CO (US); Anya Grechka, Lyons, CO (US); Isaac Squires, Boulder, CO (US)

(21) Appl. No.: 15/712,986

(22) Filed: Sep. 22, 2017

Related U.S. Application Data
(60) Provisional application No. 62/398,990, filed on Sep. 23, 2016.

(51) Int. Cl. G06Q 30/02; G09F 3/00; G06F 11/34; G06F 17/30

(52) U.S. Cl. CPC G06Q 30/02; G06F 17/30876; G06F 11/3438; G09F 3/0297

(57) ABSTRACT

Aspects of the present disclosure relate to systems and method for providing a managed user experience for consumer products. A base station may detect a tag associated with a consumer product, which may be used to retrieve a managed user experience cached locally, or stored at a remote device associated with an experience provider. The managed user experience may include gameplay, content, and/or instructions to perform specified functionality. In an example, content and/or instructions may be transmitted to the consumer product and/or one or more intermediary devices in order to generate the managed user experience. In some examples, information may be received from the consumer product by way of the tag and used to provide the managed user experience. In other examples, the tag may be retrieve and/or provide aspects of a managed user experience from an experience provider without use of the base station or intermediary device.

### CROSS-REFERENCE TO RELATED APPLICATION

This application claims priority to U.S. Provisional Application No. 62/398,990, entitled “Systems and Methods for Managing a User Experience for Consumer Products,” filed on Sep. 23, 2016, the entire disclosure of which is hereby incorporated by reference in its entirety.

### BACKGROUND

The distribution of data over networks has made it possible to regularly provide users with new content and experiences when using electronic applications. As a result, content providers are able to continually update their products to include new content for users. For example, it is now commonplace in the video game industry to extend gameplay by offering downloadable content which can add new features and content to existing games. However, in order to access additional content, features, and experiences, a device with ample processing power and the ability to connect to remote devices is required. As a result, many consumer products are not able to access additional content or user experiences.

It is with respect to these and other general considerations that the aspects disclosed herein have been made. Also, although relatively specific problems may be discussed, it should be understood that the examples should not be limited to solving the specific problems identified in the background or elsewhere in this disclosure.

### SUMMARY

Aspects of the present disclosure relate to systems and method for providing a managed user experience for consumer products. A base station may be operable to detect a tag associated with a consumer product. Upon detecting the tag, the base station may retrieve a managed user experience cached locally, or from a remote device associated with an experience provider. The managed user experience may include gameplay, content, and/or instructions to perform specified functionality in accordance with the managed user experience. In an example, content and/or instructions may be transmitted to the consumer product and/or one or more intermediary devices in order to generate the managed user experience. In some examples, information may be received from the consumer product by way of the tag and used to provide the managed user experience. In other examples, the tag may be retrieve and/or provide aspects of a managed user experience from an experience provider without use of the base station.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Additional aspects, features, and/or advantages of examples will be set forth in part in the description which follows and, in part, will be apparent from the description, or may be learned by practice of the disclosure.

### BRIEF DESCRIPTION OF THE DRAWINGS

Non-limiting and non-exhaustive examples are described with reference to the following figures.

FIG. 1A illustrates an exemplary system operable to manage user experience for consumer products.

FIG. 1B is a block diagram of an exemplary tag for use with a consumer product.

FIG. 2 depicts an exemplary method for providing a managed user experience.

FIG. 3 depicts an exemplary method for relaying tag information from a consumer product to a base station

FIG. 4A depicts an exemplary method for generating a managed user experience.

FIG. 4B depicts an exemplary method for providing a managed user experience by a tag of a consumer product.

FIG. 4C depicts an exemplary method for communicating with a consumer product by a tag.

FIG. 5 depicts an exemplary method 500 for the generation of a managed user experience by a party other than the experience provider

FIG. 6 depicts an exemplary method 600 for dynamically creating a managed user experience.

FIG. 7 depicts an exemplary method 700 for generating an experience report for a consumer product.

FIG. 8 is a block diagram of an exemplary base station.

FIG. 9 illustrates one example of a suitable operating environment in which one or more of the present embodiments may be implemented.

### DETAILED DESCRIPTION

The Internet has provided content producers with the ability to continually provide updated content and user experiences for products. Aspects disclosed herein relate to a platform operable to provide updated user experiences for consumer products, such as toys, that are not capable of individually accessing updated content or experiences. Further aspects of the disclosure relate to a system in which multiple consumer products may be used create an immersive user experience. As a result, the systems and methods disclosed herein are operable to provide managed user experience to users of physical consumer products.

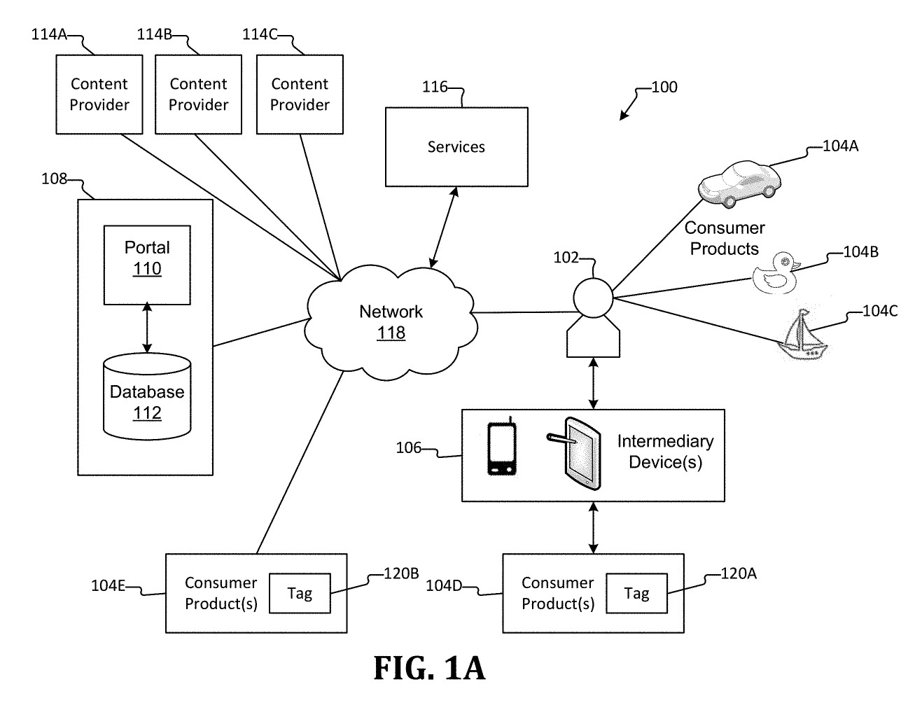

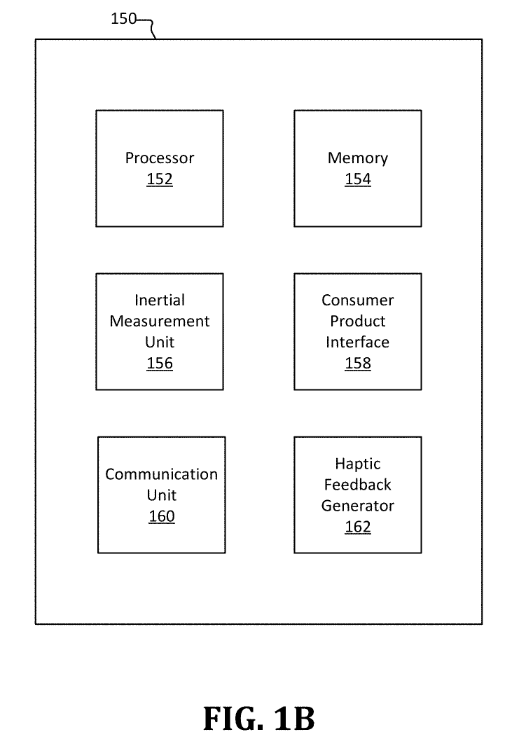

FIG. 1A illustrates an exemplary system 100 operable to manage user experience for consumer products. In various aspects, the system 100 is operable to provide enhanced functionality to various different types of consumer products in order to manage the user experience with respect to the consumer products. In various aspects, managing the user experience may include different factors such as providing content, providing gameplay, adjusting environmental settings, and/or providing enhanced functionality. Providing content may include providing audio and/or visual content associated with a consumer product. Providing gameplay may include initiating a game associated with the consumer product. Adjusting environmental settings may include instructing one or more devices to modify the environment in which the consumer product is used (e.g., adjusting light, providing sound effects, etc.). Providing enhanced functionality may comprise providing instructions to a consumer product to perform the enhanced functionality and/or receiving information from the consumer product which may be used when providing the enhanced functionality. In such examples, the instructions may provide additional content (e.g., sounds, lights, audio files, games, etc.) that the consumer product was not originally programed to do at the time of manufacture. Alternatively, or additionally, the instruction may provide the consumer product with the ability to perform functionality beyond the original functionality of the consumer product. For example, information may be received from the consumer product and/or processed at the product (e.g., user input at one or more buttons, sensor information, stored data, etc.), which may be used when providing the managed user experience. In alternate examples, the consumer product may not be capable of performing some or all of the enhanced functionality provided by the system 100. The inability to perform the enhanced functionality may be the result of the limitations of the consumer product. For example, if the consumer product does not include a speaker, the consumer product will not be able to perform audio related enhanced functionality. In such examples, other devices, such as the base station 102 or an intermediary device 106, may be instructed to perform the enhanced functionality for the consumer product. The system 100 may provide the various factors discussed in this disclosure individually or in combination in order to manage a user experience with one or more consumer products.

System 100 includes a base station 102 operable to identify and/or communicate with one or more consumer products, such as consumer products 104A-C. As used herein, a consumer product may be merchandise or other items ordinarily purchased by individuals or households. Consumer products may also include consumer durables, consumer non-durables, and soft goods. Examples of consumer products include toys, clothing, household items, and the like. In some examples, the consumer product may be an electronic product. In other examples, the consumer product may not be an electronic product. In examples, the consumer products 104A-E may include a tag that provides functionality according to aspects disclosed herein. In an example, a tag may be removable, such that it may be transported among a variety of consumer products (e.g., tags 120A-B may be removed from consumer products 104D-E). In another example, a tag may be internal to the consumer product or otherwise integrated (e.g., consumer products 104A-C are illustrated as comprising internal tags).

The information provided by the tag may convey identification information in the form of an alphanumeric identifier, a product name, a product type, manufacturer information, and the like. In examples, identification information may be used to uniquely identify a product (e.g., as compared to other product types, products of the same type, products from the same manufacturer, etc.). In an example, the information may be determined by communicating with the consumer product and/or based on information stored or generated by the tag, among other sources. In some examples, identification information conveyed by a tag may be used to identify a user, such that information relating to a managed user experience may be customized or stored for the identified user. Thus, a consumer product may be used by a plurality of users, wherein each user may have a tag that identifies the user. As a result, user-specific information may be when providing a managed user experience for a user based on the identification information provided by the tag. In other examples, identification may be used to determine an identity for the consumer product.

For example, a first user may be associated with identification information of tag 120A, while a second user may be associated with identification information of tag 120A. Thus, when consumer product 104D is used by the first user, the identification information of tag 120A may be used to access user-specific information (e.g., stored information, preferences, session information, etc.). Similarly, when consumer product 104E is used by the second user, the identification information of tag 120B may be used to access user-specific information for the second user. If the first user then wishes to use consumer product 104E, the first user may use tag 120A with consumer product 104E, thereby enabling user-specific information for the first user to be accessed when the first user interacts with consumer product 104E. Thus, it may be possible for multiple users to use the same consumer product while providing convenient user-switching by way of tags 120A-120B. It will be appreciated that while user-switching is discussed with respect to tags 120A-120B, similar functionality may be provided by a consumer product with an internal tag. For example, the tag may provide different identification information based on a user selection at the consumer product or the tag may receive identification information from an external device, among other examples.

Alternatively, or additionally, the tag may convey information about the capabilities of the consumer product and/or enable communication with the consumer product. The type of the tag employed by the system may vary. In one example, the tag may be as simple as an RFID tag. In other examples, a complex tag may be employed by the system 100. For example, the tag may be a radio and/or a sensor stack incorporated into the consumer product. In one example, a tag may comprise an inertial measurement unit (IMU) or Bluetooth low energy (BLE) radio. In another example, a tag may communicate with a processor and/or other hardware (e.g., a motor, an LED, a sensor, etc.) of the consumer product, such that command may be received by the tag and relayed to aspects of the consumer product. As such, system 100 is capable of employing various different types of tags simultaneously. The different types of tags may provide varying levels of capabilities for the consumer product. This provides the manufacturer of the consumer product with the ability to select the type of tag and/or capabilities to incorporate into the consumer product. As used herein, communicating with a consumer product may occur via a tag (e.g., an internal tag such as those of consumer products 104A-C or a removable tag such as tags 120A-B), such that instructions and/or information may be relayed between the consumer product and an external device by way of the tag.

In one aspect, a tag may be a physical component that is part of a consumer product. In such aspects, a tag may include or interface with (e.g., by way of a processor of the consumer product, etc.) one or more different hardware components such as one or more processors, lights, buttons, sensors (accelerometers, gyroscopes, etc.), IMU, and communications components. The tag may be operable to interface with a consumer product, a base station, or a third party device such as a phone, a tablet, etc. In other aspects, rather than being a physical component that is part of a consumer product, a tag may be identifying information that can be transmitted to the base station. In such examples, the tag may be information associated with a consumer product (e.g., stored in memory) that can be used to identify the consumer product and or capabilities of the consumer product to the base station, other consumer products, and/or third party devices.

In one example, when the consumer product 104A-C is within a detectable proximity of the base station 102, the base station 102 may detect tag therein to identify the consumer product 104A-C. In some examples, the base station 102 may communicate with consumer product 104A-C by way of a detected tag (e.g., to access identification information, communicate with a processor of consumer product 104A-C, etc.). The detectable proximity may vary depending upon the type of tag incorporated by the consumer product. For example, the detectable proximity for a RFID tag may be nearer to the base station 102 than the detectable proximity for a more complex tag that incorporates or otherwise utilizes a radio, such as, for example, a WiFi transmitter, a Bluetooth transmitter, a BLE transmitter, and the like. In further examples, an intermediary device may be utilized to transmit a consumer product's tag to the base station 102. For example, intermediary device 106 may be operable to identify and/or communicate with tag 120A associated with consumer product 104D and relay information between tag 120A and base station 102. Exemplary intermediary devices include, but are not limited to, a smartphone, a smart watch, a wearable device, a virtual reality headset, an augmented reality headset, a laptop or tablet computing device, another consumer product, and the like. As such, the intermediary device 106 may be operable to increase detectable proximity around base station 102 for low complexity tags. Furthermore, as will be discussed in further detail below, system 100 may also utilize intermediary device 106 to perform enhanced functionalities related to a managed user experience for a consumer product, such as consumer product 104D. In another example, a tag may directly communicate with a network (e.g., without a base station and/or intermediary device). For example, consumer product 104E and tag 120B are illustrated as directly communicating with network 118.

Upon detection of a consumer product 104A-E, a managed user experience may be provided to the detected consumer product (e.g., via base station 102 for consumer products 104A-104C, via base station 102 and intermediary device 106 for consumer product 104D, and by way of a network connection between network 118 and tag 120B for consumer product 104E). As noted above, a managed experience may include providing content, enhanced functionality, gameplay, specific environmental settings, etc., related to the detected consumer product 104A-E. In one example, the factors of the managed experience may be associated with the consumer product 104A-E. In such examples, upon detecting a tag, the tag may be used as an identifier to identify a managed experience for the consumer product 104A-E. In one example, the managed experience may be cached locally at the base station 102. Alternatively, the managed experience may be stored at a remote location, such as experience provider 108.

When the managed experience is stored remotely, the base station 102 may communicate with the experience provider 108 via network 118 and/or consumer product 104E may communicate with the experience provider 108 via network 118. Network 118 may be any type of communications network including, but not limited to, a WAN, a LAN, a POTS network, a cellular data network, the Internet, or any other type of network. In such examples, information relating to and/or received from the tag may be transmitted to the experience provider 108 via network 118. The experience provider 108 may include a data store 112 that includes information about a managed user experience for the consumer product. In one example, the managed user experience stored in the data store 112 may be indexed by the tag or by a consumer product identifier. In one example, the data store 112 may store managed user experiences for individual consumer products or may store managed user experiences applicable to a class of consumer product. The experience provider 108 may retrieve the managed user experience using the tag and provide the managed user experience (e.g., to the base station 102 and/or directly or indirectly to the consumer product tag). In one example, the experience provider 108 may be a single server and/or data store. In an alternate example, the experience provider 108 may be a distributed network (e.g., a cloud network) comprising multiple servers and/or data stores.

Providing the managed user experience may include sending content, user-specific information, instructions to perform enhanced functionality, or any of a variety of other information. As an example, the instructions to perform the enhanced functionality may be executed by the base station 102, a consumer product 104A-E, an intermediary device 106, or by a combination of the base station 102, consumer product 104A-E, and the intermediary device 106. In another example, providing the managed user experience may receive receiving information from base station 102, intermediary device 106, and/or consumer product 104A-E. For example, a tag of a consumer product may communicate and/or interpret sensor information (e.g., from an IMU, microphone, etc.), which may be received by base station 102 and/or experience provider 108 and used to generate aspects of the managed user experience.

Upon receiving the managed user experience (or retrieving the managed user experience from local storage) the base station 102 and/or consumer product 104A-E may determine how to perform the user experience. As previously noted, performance of the managed user experience may include performing enhanced functionality, providing content, executing gameplay, etc. The information related to the managed user experience may be evaluated in order to determine what actions are to be performed. Based upon the evaluation, the base station 102 may perform some actions itself, such as playing audio, displaying video, initiating gameplay, and the like. Alternatively, or additionally, based upon the evaluation, other devices may perform actions related to the managed user experience (e.g., as a result of receiving aspects of the managed user experience, receiving instructions from base station 102, etc.). For example, the base station may provide content to consumer products 104A-D along with an instruction to play the content to one or more of the consumer products 104A-D and/or the intermediary device 106. In another example, consumer product 104E may receive content and/or instructions via network 118 to play the content and/or perform the received instructions. In further examples, instructions may be provided to other devices to perform additional functionality. For example, the base station 102 may transmit instruction to a consumer product 104A-D that, when executed by the consumer product 104A-D, causes the consumer product to perform functionality that was previously unavailable to the consumer product 104A-D.

In one aspect, the managed user experience may be determined by the experience provider 108. In such examples, the experience provider 108 may collect information about how a consumer product 104A-E is used from the base station 102, from an intermediary device 106, and/or directly from the consumer product 104A-E. In such examples, the experience provider 108 may analyze the data, for example, using machine learning algorithms, to automatically determine a managed user experience for the consumer product 104 A-E. Alternatively, or additionally, a third party may define a managed user experience for the consumer product 104A-E. Exemplary third parties include, but are not limited to, a content distributor, a content owner, a content provider, a manufacturer of a consumer product, and the like.

Experience provider 108 may provide a portal 110 that allows third parties to define a managed user experience. Portal 110 may be an application or a user interface for defining managed user experiences for a consumer product. As depicted in system 100, a number of third party content providers 114A-C may be operable to access portal 110 via network 118. A third party, such as content provider 114A may define a managed user experience for a particular consumer product via portal 110. The managed user experience defined by the third party may be associated with a particular consumer product tag or identifier and stored in data store 112. As an example, a managed user experience created using portal 110 may be defined to comprise content, settings, instructions (e.g., as may be processed by experience provider 108, base station 102, consumer products 104A-E, intermediary device 106, etc.), or expected sensor input (e.g., as may be received from consumer products 104A-E, base station 102, consumer products 104A-E, intermediary device 106, etc.), among other aspects. Upon receiving identifying information for the particular consumer product, the third party defined managed user experience may be provided to the base station 102.

In one example, portal 110 allows a third party to define a custom managed user experience for a consumer product or products. Alternatively, portal 110 may provide access to a number of generic managed user experiences. A third party may be able to select one or more of the generic managed uses experience to associate with a consumer product. For example, rather than defining custom managed user experiences, a manufacturer of a consumer product may be able to select previously defined managed user experiences for their products. As such, the portal 110 may act as a managed user experience store in which content providers can sell managed user experiences to consumer product manufacturers.

In further examples, third party services 116 may be accessible to base station 102, consumer products 104A-E, and/or experience provider 108 via a network. In examples, base station 102 may access third party services 116 to perform specific tasks. As such, the capabilities of the base station 102 may be enhanced using third party services 116. As an example, rather than implementing a local natural language understanding engine, base station 102 may access a third party service 116 to perform speech recognition. Continuing with the example, base station 102 may receive speech input. The received speech input may be passed to a third party service 116, such as an online speech recognition service, to analyze and interpret the speech input and the return results of the analysis to the base station 102. Through the use of third party services 116, the capabilities of base station 102 may be enhanced. As illustrated in FIG. 1A, the system 100 is a scalable system in which various different components can be dynamically added or subtracted in order to provide a managed user experience for consumer products.

FIG. 1B is a block diagram of an exemplary tag 150 for use with a consumer product. In various aspects, tag 150 is operable to act as a bridge or relay between a consumer product and an experience provider. For example, tag 150 may communicate with the consumer product in order to obtain identification information, determine consumer product capabilities, provide instructions to the consumer product, and/or receive sensor information from the consumer product. In another example, tag 150 may communicate with an experience provider in order to provide identification information, receive information relating to a managed user experience, and/or provide sensor information that may be used by the managed service provider when providing a managed user experience. As described above, tag 150 may be integrated into a consumer product (e.g., consumer products 104A-C in FIG. 1A) or may be removable (e.g., tags 120A-B of consumer products 104D-E, respectively).

As illustrated, tag 150 is comprised of processor 152, memory 154, inertial measurement unit (IMU) 156, consumer product interface 158, communication unit 160, and haptic feedback generator 162. While tag 150 is illustrated as comprising elements 152-162, it will be appreciated that, in other examples, a tag may comprise fewer, additional, or alternative elements. As an example, a tag may merely comprise processor 152, memory 154, and communication unit 160, so as to provide information stored by memory 154 via communication unit 160. In another example, tag 150 may comprise additional sensors (e.g., in addition to IMU 156), such as a microphone, a light sensor, or a temperature sensor.

Memory 154 may comprise identification information for tag 150, such as an alphanumeric identifier, a globally unique identifier, manufacturer information, and the like. In an example, the identification information stored by memory 154 may be used to identify tag 150 and, in some cases, a user associated with tag 150. As a result, tag 150 may be used with different consumer products, such that user-specific information may be associated with the identification information, thereby providing different user profiles for a consumer product based on which tag is used with the consumer product. In another example, memory 154 may store user preference information, session information, or other information processed or received by processor 152.

As illustrated, tag 150 comprises IMU 156, which may be used to sense acceleration, rotation, and other positioning information for tag 150. Information gathered by IMU 156 may be processed at processor 152 and/or communicated using communication unit 160 (e.g., to an experience provider). It will be appreciated that fewer, additional, or alternative sensors may be part of tag 150. In examples, information generated by IMU 156 may be evaluated when providing a managed user experience according to aspects disclosed herein. For example, processor 152 may evaluate instructions in conjunction with information generated by IMU 156 in order to provide enhanced functionality. In another example, the generated information may be evaluated externally (e.g., by a base station, an intermediary device, and/or an experience provider) when providing the managed user experience.

Consumer product interface 158 may be used to communicate with a consumer product. For example, consumer product interface 158 may communicate with a processor of a consumer product, access information stored by a consumer product, receive information from one or more sensors of a consumer product, and/or control motors, LEDs, or other aspects of a consumer product. As an example, instructions may be received via communication unit 160 and processed by processor 152, which may be provided to a consumer product via consumer product interface 158. In another example, information may be accessed by consumer product interface 158 (e.g., identification information), which may be provided via communication unit 160 to a base station, an intermediary device, and/or an experience provider. In some examples, a consumer product may not comprise a processor, such that consumer product interface 158 may interface with leads and/or wires for directly controlling the consumer product (e.g., accessing a memory, activating an LED or motor, controlling a sensor, etc.). It will be appreciated that consumer product interface 158 may comprise wired communication (e.g., physical leads or contacts, etc.), wireless communication (e.g., RFID, Bluetooth, BLE, WiFi, etc.), or any combination thereof.

Communication unit 160 may be used by tag 150 to communicate with an external device. In an example, communication unit 160 may comprise hardware useable to communicate via one or more technologies, including, but not limited to, Bluetooth, BLE, WiFi, Zigbee, IR, radio frequencies, Ethernet, etc. In an example, communication unit 160 may communicate with a base station (e.g., base station 102 in FIG. 1A), an intermediary device (e.g., intermediary device 106), and/or directly via a network (e.g., network 118). While example communication techniques and technologies are disclosed herein, it will be appreciated that any of a variety of other techniques and/or technologies may be used.

Tag 150 further comprises haptic feedback generator 162. Haptic feedback generator 162 may be used by processor 152 to generate haptic feedback. In an example, processor 152 may receive instructions via communication unit 160 to provide haptic feedback, which may cause processor 152 to use haptic feedback generator 162 to generate haptic feedback. In another example, processor 152 evaluate information available from tag 150 and/or a consumer product in order to determine whether to generate haptic feedback using haptic feedback generator 162. In examples, haptic feedback generator 162 may be used to provide aspects of a managed user experience and/or diagnostic information. While tag 150 is illustrated as having haptic feedback generator 162, it will be appreciated that other user interaction components may be used, including, but not limited to, an LED and/or a speaker.

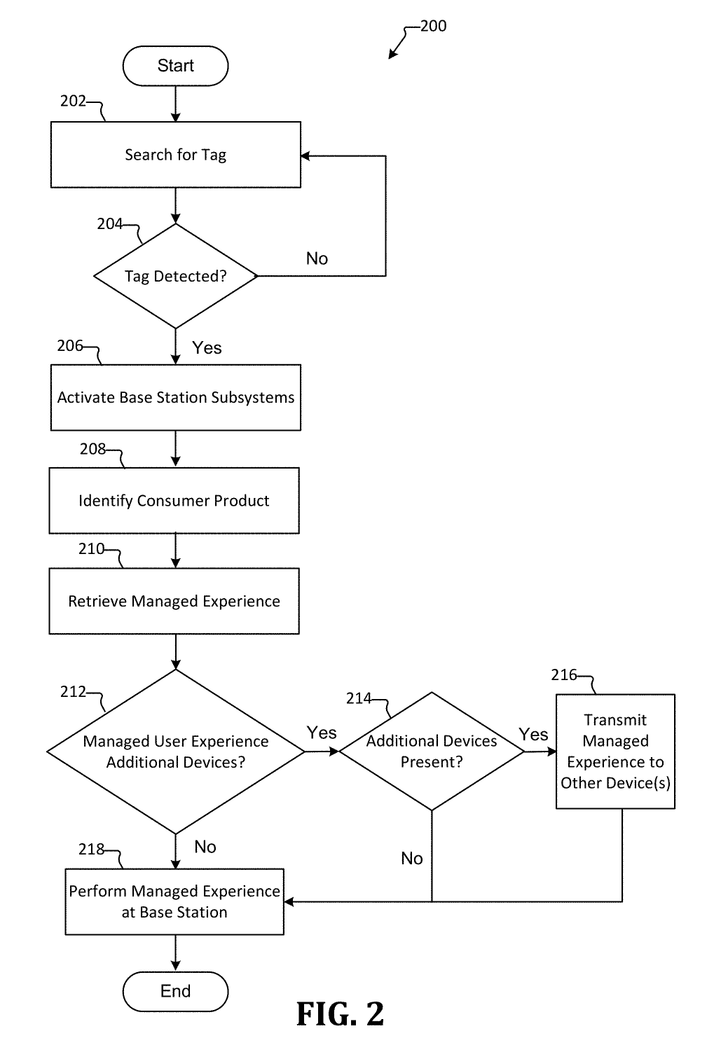

Having described overall systems for providing managed user experiences for various consumer products, the various methods performed by different components in the system will now be described. FIG. 2 depicts an exemplary method 200 for providing a managed user experience. In one example, the method 200 may be performed by a base station, such as base station 102 depicted in FIG. 1A. Alternatively, the method 200 may be performed by an intermediary device, such as intermediary device 106, or any other type of computing device. Flow begins at operation 202 where the device performing the method 202 searches for a tag. As previously described, the tag may be part of or otherwise associated with a consumer product, such as a toy. The tag may be detected via one or more radio receivers that are part of or otherwise connected to the device performing the method 200. For example, a WiFi receiver, a Bluetooth receiver, a BLE receiver, or any other type of receiver may be used to detect a tag. In one example, a tag may automatically be detected when the tag is within a certain proximity of the device performing the method 200. In one example, the device performing the method 200 may perform a scan to detect a tag. The scan may be performed upon powering up the device, periodically, or in response to an action, such as, for example, an instruction to connect to a consumer product. As depicted by decision operation 204, the device performing the method 200 may continue to scan for a detectable tag until a tag is detected. Upon detecting a tag, flow branches YES from operation 204 to operation 206.

At operation 206, one or more of subsystems may be activated in response to detecting the tag. For example, a base station performing the method 200 may be in an “Always On” low power mode. Upon detecting a tag, the various subsystems of the base station may be activated. In an alternate example, certain subsystems may be activated depending on the type of tag that is identified. If, upon detecting the tag, a determination is made as to the capabilities of the consumer product, only the subsystems capable of interacting with the consumer product may be activated. For example, if the consumer product associated with the tag is capable of communicating via Bluetooth, the Bluetooth subsystem of the device performing the method 200 may be activated; otherwise, if the consumer product is not capable of communication via Bluetooth, the Bluetooth subsystem of the device performing the method 200 may not be activated in order to save power.

At operation 208, the consumer product associated with the tag may be determined. In one example, the tag may include or provide information identifying the consumer product. For example, the tag may transmit the name or type of a toy, a serial or model number, or other identifying information. In an example, the tag may determine the transmitted information by communicating with the consumer product (e.g., a processor, a storage device, etc.). Alternatively, the tag may include a string identifier. In such embodiments, a lookup may be performed to match the string identifier to a consumer product. As used herein, a tag identifier may comprise identifying information relating to a consumer product and/or a tag. In one example, a table or data store associating tag identifiers with a string identifier may be stored locally. In such examples, the lookup may be performed locally by the device performing the method 200. Alternatively, a request may be sent to a remote device, for example, a server associated with an experience provider, to identify a consumer product associated with the detected tag. Additional information may also be determined at operation 208 such as a user associated with the consumer product, versioning information, the number of times the consumer product has been used, the date/time of last use, etc.

Upon identifying the consumer product, flow continues to operation 210 where a managed user experience is retrieved. The managed user experience may be cached locally at the device performing the method 200. Alternatively, the managed user experience may be cached on a remote device, such as a device associated with an experience provider. In one example, retrieving the managed experience may comprise first searching local storage for a managed experience and, if the managed experience does not reside locally, sending a request to a remote device for a managed experience associated with the consumer product. As previously discussed, the managed experience may include content (e.g., audio and visual content), gameplay (e.g., a game related to the consumer product), instructions to perform enhanced functionality, and/or environmental settings (e.g., adjusting the light settings of a room or a device, projection of an augmented reality visualization, a virtual reality visualization, etc.).

Upon retrieving a managed user experience, flow continues to decision operation 212 where a determination is made as to whether the managed user experience requires actions by one or more additional devices. For example, the managed user experience may require the consumer product, or a different consumer product, to perform a specific operation, such as playing a sound, activating a particular operation mode, communicating with another device, etc. Similarly, the managed user experience may require action by an intermediary device, such as a smartphone, a smartwatch or other types of wearable devices, a virtual reality headset, an augmented reality headset, etc. In further examples, the managed experience may require actions by other types of devices. As the Internet of Things continues to expand, many other types of devices may be leveraged to provide a managed user experience such as smart televisions, smart appliances, smart thermostats, and the like. One of skill in the art will appreciate that any type of device capable of communicating with the device performing the method 200 may be utilized as part of a managed user experience.

If the managed user experience does not require action by other devices, flow branches NO to operation 218. At operation 218, the device performing the method 200 may perform actions as part of the managed user experience. For example, the device may be a base station such as base station 102 of FIG. 1A. At operation 212, the base station may play audio, play video, activate a game, display colored lights, etc. As such, the base station may provide an enhanced user experience for a consumer product regardless of whether the consumer product is capable itself of providing the managed user experience. As an example, the consumer product may be a toy car that is equipped with an RFID tag. The toy car may not include any electronics and, therefore, may not be capable of providing any additional capabilities. However, upon detection of the toy car's tag, the base station may reproduce sounds of a race track, thereby creating a play atmosphere akin to a race in order to enhance a child's play experience with the toy car.

Returning to decision operation 212, if the managed user experience includes actions by additional devices, flow branches YES to operation 214 where a determination is made as to whether the additional devices are present. The systems and methods disclosed herein are operable to scale the user experience depending upon the types of additional devices available. As such, a managed user experience may include actions performed by any number of devices. When all devices are present, each device may be instructed to perform actions to enhance the managed user experience. However, if some devices are not present, only the devices present may be instructed to perform actions related to the managed user experience. In still further embodiments, the types of actions performed by the various different devices may vary depending upon the available devices. As such, the content and/or instructions transmitted to a particular device may be altered depending on the other devices present. If none of the additional devices that are part of the managed user experience are present, flow branches NO to operation 218 where the device performing the method 200 performs actions in accordance with the managed user experience. If, however, other devices are present, flow branches YES to operation 216. At operation 216, the device performing the method 200 transmits content and/or instructions to the additional devices based upon the retrieved managed user experience.

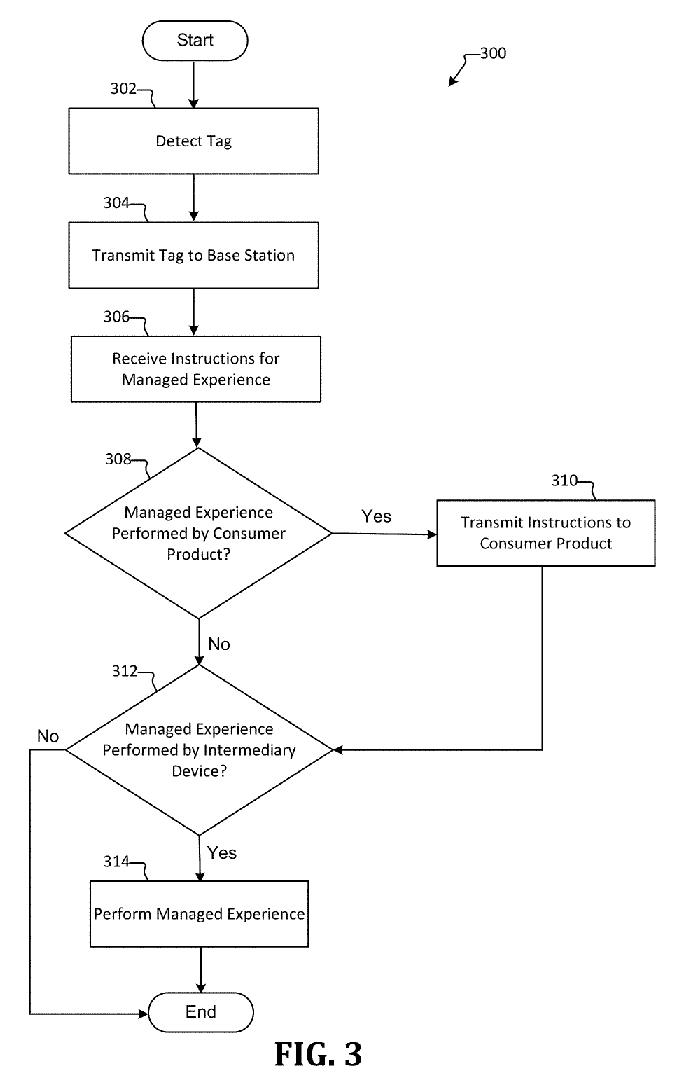

FIG. 3 depicts an exemplary method 300 for relaying tag information from a consumer product to a base station. In one example, the method 300 may be performed by an intermediary device, such as intermediary device 106 depicted in FIG. 1A. Types of intermediary devices include, but are not limited to, smartphones, smart watches, wearable devices, virtual reality headsets, augmented reality headsets, laptops, tablets, or other types of computing devices. Flow begins at operation 302 where a tag is detected. The tag may be detected via one or more radio receivers that are part of or otherwise connected to the intermediary device performing the method 300. For example, a WiFi receiver, a Bluetooth receiver, a BLE receiver, or any other type of receiver may be used to detect a tag. In one example, a tag may automatically be detected when the tag is within a certain proximity of the device performing the method 300. In one example, the device performing the method 300 may perform a scan to detect a tag. The scan may be performed upon powering up the device, periodically, or in response to an action, such as, for example, an instruction to connect to a consumer product.

Upon detecting the tag, flow continues to operation 304 where the tag information is transmitted to the base station. In one example, a connection may be established between the base station and the intermediary device. Upon establishing the connection, the tag, or a subset of information derived or received from the tag, may be transmitted to the base station. Alternatively, instead of directly transmitting the tag to the base station, the tag may be transmitted to the base station via one or more additional intermediary devices. In an example, the information from the tag may be based on information accessed from the consumer product by the tag, according to aspects disclosed herein.

In response to transmitting the tag to the base station, information related to a managed user experience for the consumer product associated with the tag may be received at operation 306. The information received at operation 306 may include content related to the managed user experience (e.g., audio, video, and/or text content) and/or instructions to perform certain operations in accordance with the managed user experience. The information received at operation 306 may be for the intermediary device performing the method 300, the consumer product identified by the tag, or both.

Flow continues to decision operation 308 where a determination is made as to whether the managed user experience requires any the performance of any operations by the consumer product. In one example, the information received at operation 306 may indicate whether the consumer product is to perform any specific operations. If no actions are required by the consumer product, flow branches NO to operation 312. If, however, the managed user experience includes operations performed by the consumer product, flow branches YES to operation 310. At operation 310, instructions related to the managed user experience are transmitted to the consumer product. The instructions may be transmitted to the consumer product via a wireless data connection and, in some examples, may be received by a tag of the consumer product. The instructions transmitted to the consumer product may cause the consumer product to perform a specific operation, enter a certain operational mode, and/or play specified content when executed by the consumer product. The instructions transmitted at operation 310 may be transmitted with additional content, such as audio content, video content, or gameplay content.

While certain aspects of method 300 are described with respect to a consumer product merely receiving instructions, it will be appreciated that other examples may comprise receiving information from the consumer product in order to determine aspects of the managed user experience. As an example, sensor information may be received from the consumer product, which may be used to adapt an audio stream playing at the consumer product to incorporate relevant sound effects. In an example, information may be received from and provided to the consumer product using a tag, as described herein. Flow then continues to operation 312.

At operation 312, a determination is made as to whether the managed user experience includes actions to be performed by the intermediary device. The determination may be made based upon the information received at operation 306. If no additional actions are to be performed by the intermediary device, flow branches NO and the method 300 completes. If, however, the instructions received at operation 306 specify operations to be performed by the intermediary device, flow branches YES to operation 314. At operation 314, the intermediary device performs actions in accordance with the managed user experience. For example, at operation 314 the intermediary device may play audio, video, or gameplay content, may enter a specified operational state, or perform any other type of operation. In another example, information received from the consumer product may be used by the intermediary device to provide aspects of the managed user experience.

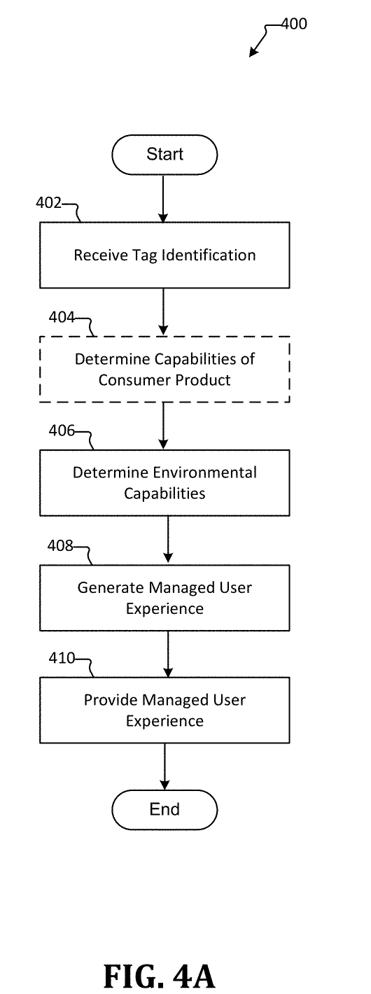

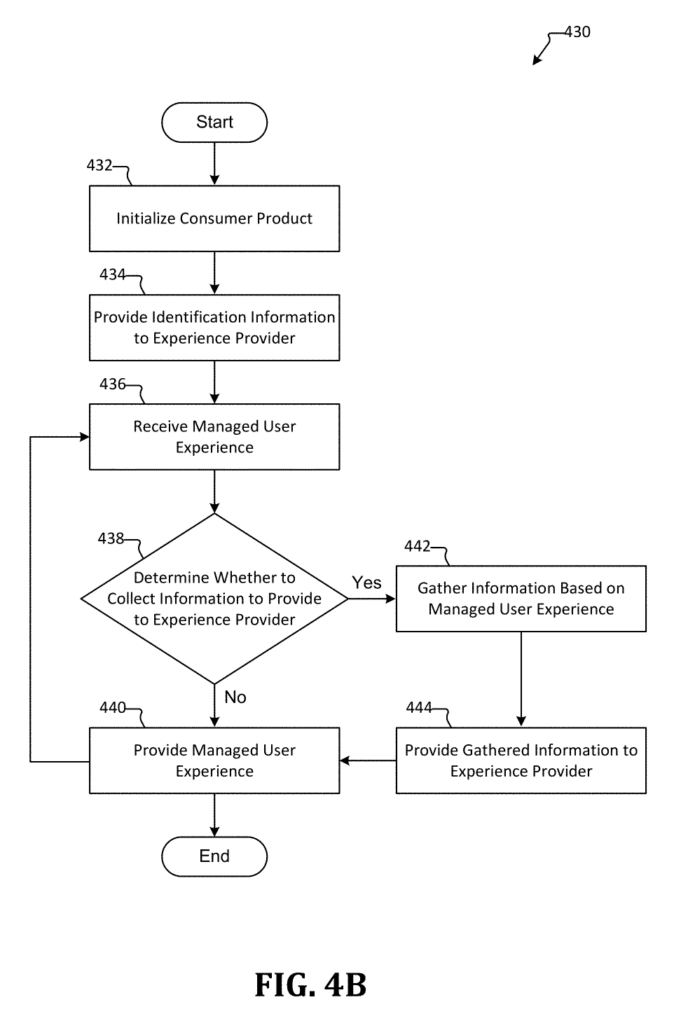

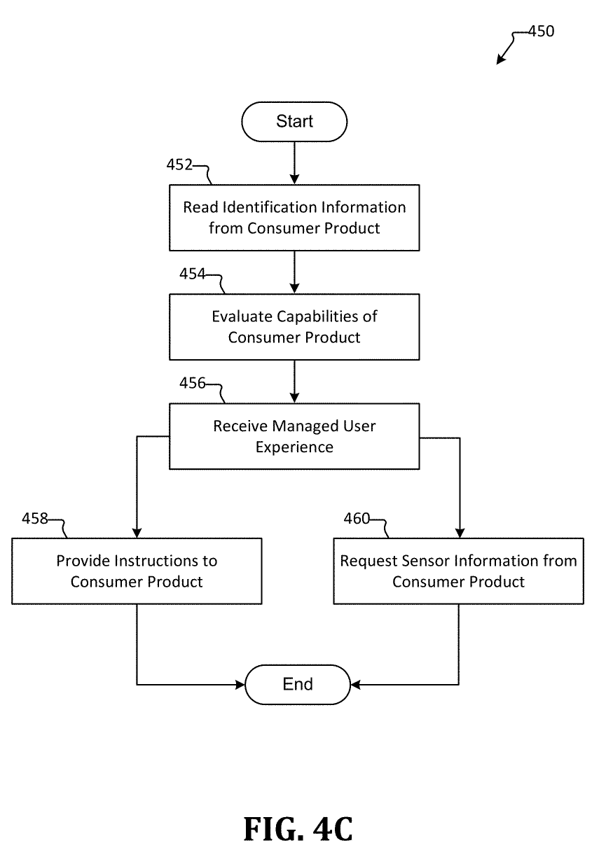

FIG. 4A depicts an exemplary method 400 for generating a managed user experience. The method 400 may be performed by a base station, such as base station 102. In alternate examples, the method 400 may be performed by one or more devices associated with an experience provider, such as experience provider 108. Flow begins at operation 402 where tag identification information is received. In one example, the tag identification information received at operation 402 may be used to identify a consumer product associated with the tag. Identification of the consumer product associated with the tag may include identifying the type and/or specific model of the consumer product. In further examples, identification of the consumer product may also include identifying additional information related to the consumer product such as a user or account associated with the consumer product, content and/or games for the consumer product that is currently available to the user, additional content and/or games that are not currently available to user but which can be acquired via purchase or update, usage history for the consumer product, etc. In some examples, the tag identification information may be received from a tag, and may comprise identification information relating to a consumer product (e.g., as the tag may determine by communicating with the consumer product) and/or identification information relating to the tag itself, among other information.

In certain examples, the managed user experience generated by the method 400 may depend upon the capabilities of the consumer product. At operation 404, the capabilities of the consumer product may be determined. The capabilities of the consumer product may be determined based upon the various components of the consumer product. For example, if the consumer product contains a display then it may be determined that the consumer product is capable of displaying video or text. In one example, the capabilities may be determined by querying the consumer product for supported capabilities. Alternatively, the capabilities of the consumer product may be recorded in a data store. In such examples, determining the capabilities of the consumer product may include searching a data store for the consumer product's capabilities.

In further aspects, a managed user experience may vary depending upon environmental capabilities. As used herein, environmental capabilities may refer to the ecosystem in which the consumer product identified by the tag currently resides in. The ecosystem may be defined by the types and capabilities of other devices located within a close proximity to the consumer product identified by the tag. That is, the capabilities of the devices located near the consumer product may be used to contribute to a managed user experience for the consumer product. As an example, devices within the consumer product's current ecosystem may be leveraged by playing audio or video content, presenting special effects, or otherwise manipulating the environment in which the consumer product is currently in use. As another example, a “smart” device within the consumer product's current ecosystem may be controlled via an application programming interface (API) in order to provide aspects of the managed user experience. For example, a smart lightbulb may be controlled using an API provided by the manufacturer.

In still further examples, the operations or actions performed by the different devices or the consumer product itself may be altered depending upon the other types of devices within proximity of the consumer product. As an example, a game associated with the consumer product may be altered to incorporate other devices. Altering the game may include modifying the game slightly to include the other devices or, in some examples, completely changing gameplay for the consumer product based upon the existence of other devices.

In one example, the ecosystem may be determined by detecting additional tags for the other devices located within proximity of the consumer product. Alternatively, a user profile may be defined which indicates other devices or consumer products owned by the user. The user profile may be manually created. That is, an interface may be provided that is capable of receiving input from the user indicated the different types of devices and/or consumer products owned by the user. Alternatively, or additionally, the profile may be automatically created by adding new devices or consumer products to the user profile each time a new tag is identified or received. The ability to automatically add new devices or consumer products allows for the dynamic management of the user profile and may ensure that the user profile is up-to-date.

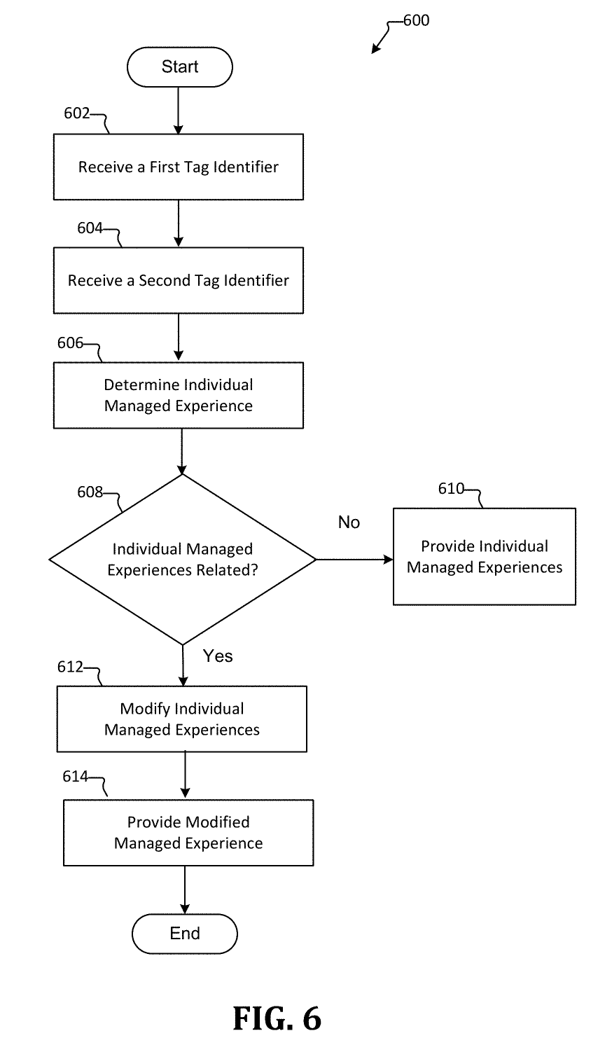

After determining the consumer product capabilities and/or the environmental capabilities, a managed user experience may be generated at operation 408. In aspects, generation of the managed user experience may include generating and/or providing instructions and/or content to the consumer product and each device in the environment individually. That is, the managed user experience may include each identified consumer product or device acting as they would independent of one another. Alternatively, the independent actions of each identified consumer product or device may be altered according to the presence or lack of other devices, as will be described in further detail with respect to FIG. 6. As such, instruction or content that would be provided based upon the presence of the consumer product by itself may be altered to shift some functionality to other devices or to perform some additional functionality based upon the presence of the other devices.

The managed user experiences may be statically or dynamically generated at operation 408. For example, the managed user experience may be statically defined for a consumer product. As previously discussed, a consumer product manufacturer may submit a managed user experience for a product for execution by the systems and methods disclosed herein. Different managed user experiences may be statically defined for a consumer product individually and in conjunction with other devices. As such, generating the managed user experience at operation 408 may comprise looking up a statically-defined managed user experience based upon the identification of the consumer product and the one or more additional consumer products or devices identified at operation 406. Alternatively, the managed user experience may be dynamically determined. In such an example, machine learning may be employed to generate a managed user experience based upon information about the consumer product, the capabilities of the consumer product, information received from the tag and/or consumer product, and information about the types and capabilities of the other devices or consumer products identified at operation 408. Other factors, such as information about the user, usage history for the consumer product, etc., may also factor into the dynamic generation of the managed user experience.

Upon generating the managed user experience, flow continues to operation 410 where the managed user experience is provided. When the method 400 is performed by a device associated with an experience provider, providing the managed user experience may comprise sending instructions and/or content related to the managed user experience to a base station or other device. In another example, the managed user experience may be provided directly to the consumer product (e.g., via network 108 to consumer product 104E in FIG. 1A). Alternatively, when the method 400 is performed by a base station, providing the managed user experience may comprise sending instructions and/or content related to the managed user experience to the consumer product and/or other devices or consumer products in proximity to the consumer product. Furthermore, providing the managed experience may include the actual execution of instructions related to the user experience by the base station.

FIG. 4B depicts an exemplary method 430 for providing a managed user experience by a tag of a consumer product. As an example, the tag may be a tag similar to tags 120A-B in FIG. 1A and/or tag 150 in FIG. 1B. For example, the method 430 may be employed by an integrated or removable tag of a consumer product, such as those of consumer products 104A-E in FIG. 1A. In some examples, the method 430 may be performed when a consumer product is identified with a base station (e.g., base station 102 in FIG. 1A), connected to an intermediary device (e.g., intermediary device 106), or connected to a network (e.g., network 118). In other examples, the method 430 may be performed when a tag is connected to a new or different consumer product (e.g., moving tag 120A from consumer product 104D to consumer product 104E, as was discussed above with respect to FIG. 1A).

The method 430 begins at operation 432, where a consumer product may be initialized. In an example, initializing the consumer product may comprise communicating with a storage device or processor of the consumer product. For example, a tag may communicate with a storage device of the consumer product in order to access identification information (e.g., a serial number, a model number, etc.) or evaluate the capabilities of a consumer product (e.g., available hardware, a hardware and/or software version, etc.). In an example, initializing the consumer product may comprise interacting with the consumer product using a consumer product interface, such as consumer product interface 158 in FIG. 1B.

At operation 434, identification information may be provided to an experience provider (e.g., experience provider 108 in FIG. 1A). In an example, the provided identification information may comprise identification information accessed from the consumer product at operation 434, which may be used to identify the consumer product. In another example, the provided identification information may comprise identification information from the tag, which may be associated with or used to identify a user. The identification information from the tag may be accessed from a memory of the tag, such as memory 154 of tag 150 in FIG. 1B. In some examples, the identification information may comprise a combination of information from both the consumer product and the tag. It will be appreciated that while example identification information is described herein, a wide variety of other identification information and associated techniques may be used.

Providing the identification information to the experience provider may comprise communicating with a base station (e.g., base station 102 in FIG. 1A), an intermediary device (e.g., intermediary device 106), and/or using a network (e.g., network 118). Thus, in some examples, communication with the experience provider may be indirect, wherein a base station and/or intermediary device may facilitate communication with the experience provider. In other examples, communication with the experience provider may be more direct (e.g., via a connection to a network as may be achieved using WiFi, a Zigbee hub, etc.).

Flow progresses to operation 436, where a managed user experience may be received. The managed user experience may be received according to aspects herein. As an example, the managed user experience may be received from a base station and/or an intermediary device, and may comprise content and/or processing instructions, among other aspects. In another example, the managed user experience may be received over a network connection to the experience provider.

At determination 438, it may be determined whether information should be collected and provided to the experience provider. In an example, the determination may comprise evaluating aspects of the received managed user experience to determine whether the managed user experience comprises evaluating information received from the tag (e.g., comprising information generated by the tag and/or consumer product). As an example, a managed user experience may indicate that the managed user experience generates consumer product feedback based on accelerometer data. As a result, accelerometer data may be collected and/or processed to be provided for processing as part of the managed user experience.

If it is determined that information should not be collected, flow branches “No” to operation 440, where the managed user experience may be provided according to aspects disclosed herein. For example, content may be provided and/or instructions may be executed. In an example, the content may comprise an audio stream received from the experience provider, wherein the experience provider may mix in sound effects and other audio data into the audio stream for playback at the tag, a base station, an intermediary device, and/or the consumer product. Flow may loop between operations 440 and 436 while providing the managed user experience, such that additional information relating to the managed user experience may be received, it may be re-determined whether to collect and provide information to the experience provider, and the managed user experience may continue to be provided.

If, however, it is determined that information should be collected to provide to an experience provider, flow branches “Yes” to operation 442 where information may be gathered based on the managed user experience. In an example, the managed user experience received at operation 436 may comprise an indication as to the type of information to collect and/or processing that should be performed on the collected information before providing the information to the experience provider. For example, the managed user experience may indicate one or more sensors of the consumer product to poll, instructions to provide to a processor of the consumer product in order to receive data from the processor, etc. Thus, in some examples, specialized information need not be known about the consumer product, but rather instructions to interface with the consumer product may be received as part of the managed user experience. Information may be collected from the tag and/or from the consumer product.

Moving to operation 444, the gathered information may be provided to the experience provider. Providing the gathered information to the experience provider may comprise communicating with a base station (e.g., base station 102 in FIG. 1A), an intermediary device (e.g., intermediary device 106), and/or using a network (e.g., network 118). Thus, in some examples, communication with the experience provider may be indirect, wherein a base station and/or intermediary device may facilitate communication with the experience provider. In other examples, communication with the experience provider may be more direct (e.g., via a connection to a network, as may be achieved using WiFi, a Zigbee hub, etc.). While method 430 is discussed with respect to providing information to an experience provider, it will be appreciated that similar techniques may be applied to a base station and/or an intermediary device as an alternative to or in addition to an experience provider.

Flow then moves to operation 440, as was discussed above. Flow may loop between operations 440 and 436, such that information may continually be gathered and provided to the experience provider. In some examples, the managed user experience may indicate that information should no longer be collected, such that flow may instead branch directly from determination 438 to operation 440 in some instances. Thus, information relating to the managed user experience may continue to be received and information may be collected and provided to the experience provider when it is indicated that the information should be collected as part of the managed user experience.

FIG. 4C depicts an exemplary method 450 for communicating with a consumer product by a tag. As an example, the tag may be a tag similar to tags 120A-B in FIG. 1A and/or tag 150 in FIG. 1B. For example, the method 450 may be employed by an integrated or removable tag of a consumer product, such as those of consumer products 104A-E in FIG. 1A. In some examples, the method 450 may be performed when a consumer product is identified by a base station (e.g., base station 102 in FIG. 1A), connected to an intermediary device (e.g., intermediary device 106), or connected to a network (e.g., network 118). In other examples, the method 430 may be performed when a tag is connected to a new or different consumer product (e.g., moving tag 120A from consumer product 104D to consumer product 104E, as was discussed above with respect to FIG. 1A).

Method 450 begins at operation 452, where identification information may be read from a consumer product. In an example, the identification information may be read from the consumer product by way of a consumer product interface, such as consumer product interface 158 in FIG. 1B. In some examples, reading the identification may comprise accessing storage of the consumer product and/or communicating with a processor of the consumer product. In other examples, reading the identification information may comprise sensing a physical component of the consumer product, such as scanning an RFID tag or a barcode. While example identification information and related techniques are discussed, it will be appreciated that other techniques may be used to determined identification information for a consumer product.

At operation 454, capabilities of the consumer product may be evaluated. In an example, the evaluation may comprise polling the consumer product for capability information (e.g., communicating with a processor of the consumer device, determining whether one or more physical connections are available or active, etc.). In another example, the evaluation may comprise evaluating the received identification information. As an example, the identification information may comprise encoded capability information (e.g., as part of a model number, a version number, etc.). In some examples, the identification information may be used to look up consumer product capabilities with an experience provider, a manufacturer, or other resource.

Moving to operation 456, a managed user experience may be received according to aspects disclosed herein. In an example, the managed user experience may comprise instructions and/or content to provide to the consumer product. In another example, the managed user experience may indicate that sensor information should be requested from a consumer product and provided for processing as part of the managed user experience. Operations 458 and 460 discussed below may be performed alternatively, in combination, or sequentially, among other examples.

At operation 458, instructions may be provided to the consumer product. In an example, providing the instructions to the consumer product may comprise communicating with a processor of the consumer product. In some examples, the instructions may be opaque to the tag, such that the tag may be unable or may not need to process the instructions. Thus, the tag may not require specialized knowledge about the consumer product, and may instead merely provide received instructions to the consumer product for processing. In other examples, providing the instructions may comprise directly controlling hardware aspects of the consumer product (e.g., controlling a motor, an LED, a speaker, etc.).

At operation 460, sensor information may be requested from the consumer product. In an example, requesting the sensor information may comprise communicating with a processor of the consumer product, which may in turn gather the sensor information from one or more sensors of the consumer product and provide the gathered information to the tag. In some examples, the consumer product and/or the tag may process the sensor information. In another example, requesting the sensor information may comprise polling or monitoring one or more sensors of the consumer product (e.g., directly receiving the sensor information without use of a processor of the consumer product). While example sensing techniques are described herein, it will be appreciated that any of a variety of techniques may be used.

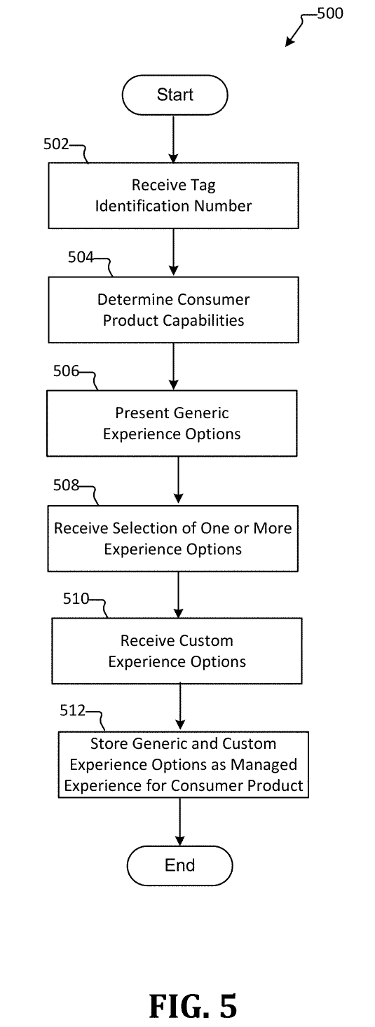

FIG. 5 depicts an exemplary method 500 for the generation of a managed user experience by a party other than the experience provider. For example, the method 500 may be employed to allow the manufacturer of a consumer product to define a managed user experience for the consumer product. The method 500 may also be employed to allow a content provider or owner to define a managed user experience based upon their content that may be associated with a number of consumer products. As an example, the method 500 may be performed by a computing device that is associated with an experience provider, such as, for example a computing device hosting the portal 110 depicted in FIG. 1A.

Flow begins at operation 502 where a tag identification number is received. The tag identification number received at operation 502 may be used to associate the managed user experience created by the method 500 with a particular consumer product or type of consumer product. The identifier provided at operation 502 may be used to associate a managed user experience with one or more consumer devices. In an example, the tag identification number may identify one or more tags and/or consumer products, according to aspects disclosed herein.

Flow continues to operation 504 where, upon determining the one or more consumer devices that the managed user experience is to be associated with, the capabilities of the consumer product may be determined. As previously discussed, the capabilities of the consumer product may be determined based upon the various components of the consumer product. For example, if the consumer product contains a display then it may be determined that the consumer product is capable of displaying video or text. In one example, the capabilities may be determined by submitting a query to a user or a data source for information about the consumer product.

In response to determining the capabilities of the device, one or more generic experience options may be provided at operation 506. As used herein, an experience option may be content and/or instructions to perform a specific operation, enter a specific operating state, etc., that may be provided as part of a managed user experience. In an example, an experience option may comprise evaluating information that may be received from a tag and/or consumer product, such as sensor information or stored preferences, among other information. As previously discussed, third party content providers may submit user experiences that can be used by various different consumer products. The third party submitted experiences may be provided as generic experience options that a user experience author can select to incorporate into the experience of a particular consumer product. The types of generic experience options provided may depend upon the type of the consumer product and/or the capabilities of the consumer product. For example, a consumer product capable of providing audio may be presented with audio experience options while a consumer product with a display may be presented with video experience options. In response to displaying the generic experience options, one or more generic experience options may be selected at operation 508. The one or more generic experience options selected at operation 508 may be included in a managed user experience for a consumer product associated with the tag identification number received at operation 502.

Flow continues to operation 510 where custom experience options may be received. The custom experience operations received at operation 510, for example, may be defined by the manufacturer of the consumer product associated with the consumer product associated with the tag received at operation 502. The custom experience options may be designed specifically for the consumer product, as opposed to generic experience options which may be designed for use by a variety of different consumer products. As an example, a custom experience option may relate to custom hardware aspects of a consumer product, such that one or more instructions relating to the custom hardware aspects may be provided to a processor of the consumer product (e.g., by way of a tag, as described herein). As a result, of receiving the instructions, custom actions may be performed by the consumer product. Thus, specialized knowledge of the consumer product may not be required by an experience provider or a tag. Rather, the manufacturer may be aware of the capabilities of the consumer product and may provide custom experience options accordingly. Receiving the custom experience options may include receiving content and/or instructions to perform a specific operation, enter a specific operating state, etc., from a manufacturer of a consumer product or from another third party. Conditions may also be received along with the custom experience options that define the circumstances and/or situations upon which the custom experience options should be employed.

At operation 512, any selected generic experience options and any received custom experience options may be used to create one or more managed user experiences. In one example, the generic and custom experience options may be aggregated into a managed user experience. This process may result in the creation of one or more statically defined managed user experiences. The managed user experience created using the generic and/or custom experience options may then be stored for later use.

FIG. 6 depicts an exemplary method 600 for dynamically creating a managed user experience. The method 600 may be performed by a base station, such as base station 102 of FIG. 1A. In alternate examples, the method 600 may be performed by one or more devices associated with an experience provider, such as experience provider 108 of FIG. 1A. Flow begins at operation 602 where a first tag identifier is received. As previously discussed, a tag identifier may identify a consumer product and/or a user. The tag identifier may be used to identify or generate a managed user experience for a consumer product. The tag identifier may be received from the consumer product itself (e.g., via a tag), via an intermediary device, or via a base station. Flow continues to operation 604 where a second tag identifier may be received. The second tag identifier may identify a second consumer product that is different from the first consumer product.

Upon receiving the first and second tag identifiers, flow continues to operation 606 where the individual managed experiences may be determined for the individual consumer products identified by the first and second tags. Flow then continues to decision operation 608 where a determination is made as to whether the individual managed user experiences for each device are related. In certain aspects, machine learning may be employed to determine whether the individual managed user experiences are related. For example, the characteristics of the individual managed user experiences (e.g., content, operations, etc.) may be compared to identify any overlapping relationships. Alternatively, or additionally, the operations of the individual managed user experiences may be evaluated to determine if execution of the operations would affect one another. If it is determined that no relationship exists between the individual managed user experiences, flow branches NO to operation 610 and the individual managed user experiences may be provided or otherwise executed for each identified consumer product.

If, however, a relationship is determined at operation 608, flow branches YES to operation 612. At operation 612, the individual managed user experiences may be modified based upon the determined relationship. Modifying the individual managed user experiences may include adjusting the managed user experiences to account for one another. In one example, adjusting an individual managed experience may include adding or removing functionality related to one of the managed user experiences based upon the operations performed by the other. Modifying the individual managed user experiences may also include adding or removing content from one or both of the individual managed experiences. As a result, new managed experiences for the consumer products may be dynamically created. The new managed experiences may allow for additional interactions between the first and second consumer products. The additional interactions may include operations that may not be performed on the individual consumer products alone.

Upon modifying the individual managed user experiences, flow continues to operation 614 where the modified user experiences are provided. When the method 600 is performed by a device associated with an experience provider, providing the managed user experience may comprise sending instructions and/or content related to the managed user experience to a base station or other device. Alternatively, when the method 600 is performed by a base station, providing the managed user experience may comprise sending instructions and/or content related modified managed user experiences to the first and second consumer products.

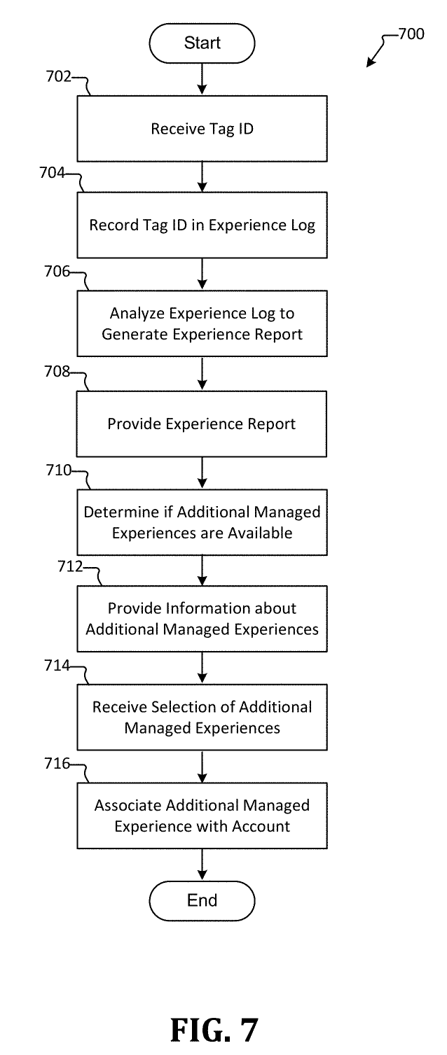

FIG. 7 depicts an exemplary method 700 for generating an experience report for a consumer product. The method 700 may be performed by a base station, such as base station 102 of FIG. 1A. In alternate examples, the method 700 may be performed by one or more devices associated with an experience provider, such as experience provider 108 of FIG. 1A. Flow begins at operation 702 where a tag identifier is detected or otherwise received. The various aspects of detecting or receiving a tag identifier disclosed herein may be employed at operation 702. Upon receiving the tag identifier, information relating to the tag identifier may be recorded in an experience log at operation 704. In one aspect, the experience log may track the amount of times a particular tag, and thus, a particular consumer product, user, or a combination thereof, has been detected. In alternate examples, additional information may be included in the experience log, such as how long the consumer product was in use, what other consumer products or devices were used with the consumer product, the exact managed user experience that was deployed for the consumer product, etc.

At operation 706, the experience log may be analyzed to generate an experience report. In one example, the experience report may include information about a specific user. For example, an experience report about a specific user may include information about all of the consumer products that the user used or a specified time period. Alternatively, an experience report may be generated based upon individual consumer products. A consumer product experience report may include information, such as the number of times the consumer product was used, the types of content accessed using the consumer product, the types of managed user experiences provided, an analysis of information received from a consumer product (e.g., a summary of sensor information, an overview of the type of information received, etc.), etc. As such, based upon analysis of the experience log, a report may be generated detailing how often a user interacted with a particular consumer product and the manner in which the user interacted with it.

At operation 708, the experience report may be provided to one or more users. In one example, the experience report may be provided to the user of the consumer product. The report may be delivered to the user via email, via text, as a document or webpage, or via an application. Alternatively, or additionally, the report may be provided to someone other than the user of the consumer product. For example, the report may be provided to a person related to or associated with the user (e.g., a parent, a relative, a teacher, etc.), a content provider, or a manufacturer. In doing so, it may be possible to evaluate user behavior in order to determine which consumer products or other types of consumer products are regularly used.

At operation 710, a determination may be made as to whether additional managed experiences are available for the one or more consumer products identified in the report. As previously discussed, an experience provider may include various different managed user experiences each of which may contain unique content and/or functionality. The different managed experiences may be accessed or purchased from an experience provider or content provider. As such, a user may not have access to all of the managed user experiences available for a particular consumer product. The experience report may be used as an indicator to determine which consumer products the user regularly uses and the consumer product is used. Such information may be utilized to identify additional managed user experiences and/or content that the user may be interested in.

At operation 712, information about the additional managed user experiences may be provided to the user or a person associated with the user such as, for example, a parent or a teacher or to an organization related to the consumer product, such as a manufacturer. In one example, the information about the additional experiences may be provided in the experience report itself. Alternatively, information about the additional user experiences may be provided in an email, via an application, or via any other type of communication mechanism known to the art.

In certain aspects, the information about the additional user experiences may include an interface that allows the user to purchase, download, or otherwise unlock the additional user experiences. At operation 714, a selection of one or more additional managed experienced may be received. In one example, the selection may be received via an online store that allows for the purchase of additional experiences. Alternatively, the selection may be received as part of an update to a consumer product. Upon receiving the selection, the one or more additional managed user experiences may be associated with a user account. Association of the additional managed user experiences with the user's account provides the user with access to the additional managed user experiences the next time the user interacts with the consumer product.

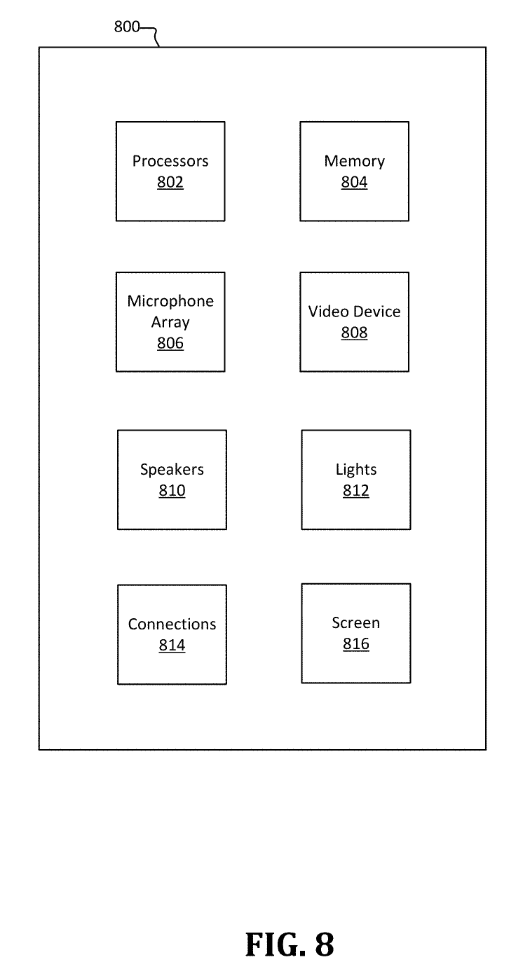

FIG. 8 is a block diagram of an exemplary base station 800. Base station 800 comprises one or more processors 804 operable configured to store and execute operations, programs or computer executable instructions stored in memory 806. Processor 804 may be operable to execute instructions in accordance with a managed user experience. Memory 806 may be volatile memory (such as RAM), non-volatile memory (such as ROM, flash memory, etc.), or some combination of the two. Memory may comprise computer storage media. Computer storage media includes volatile and nonvolatile, removable and non-removable media implemented in any method or technology for storage of information such as computer readable instructions, data structures, program modules or other data. Computer storage media includes, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other tangible, non-transitory medium which can be used to store the desired information. In one example, memory 804 is operable to store a managed user experience.

Base station 800 may also include a one or more microphones 806. In further examples, the base station 800 may include a microphone array 806. A microphone array 806 may comprise a plurality of microphones operating in tandem. The microphone array may comprise omnidirectional microphones, directional microphones, or a combination of both types of microphones. The one or more microphones may be operable to receive audio input, such as, for example, spoken input from a user.

Base station 800 may also include a video device 808. The video device may be capable of receiving video data in a compress file format (e.g., MPEG, VP8, VP9, H.264, etc.), decompressing the video, and transmitting the video to a display screen, such as screen 816. In one example, the video device 808 may be a laser projector or a pico projector capable of projecting an image on screen 816. In one aspect, screen 816 may be a spherical screen. While specific video devices and screen shapes have been disclosed herein, one of skill in the art will appreciate that other types of video devices and screens may be employed without departing from the spirit of this disclosure.

Base station 800 may also include a number of output devices, such as speakers 810 and lights 812. Speakers 810 may be operable to play audio content or provide audio game play in accordance with a managed user experience. Lights 814 may comprise LED lights, incandescent lights, or fluorescent lights. Lights 814 may be operable to change colors, dim, or brighten in accordance with a managed user experience.

Base station 802 may also contain one or more communication connections 814. Exemplary communications connections include radio frequency (RF) transmitter, receiver, and/or transceiver circuitry, infrared transmitters, universal serial bus (USB), parallel, and/or serial ports. Communications connections 814 may be operable to communicate with other devices via a number of different communications protocols, such as, WiFi, Bluetooth, BLE, etc. Communications connections 814 may be operable to detect a tag associated with a consumer product. Upon detecting a tag, communications connections 814 may be operable to communicate directly with a consumer product, for example, to deliver content or instructions related to a managed user experience to the consumer product. Communications connections 814 may also be operable to communicate with a remote device via a network. For example, communications connections may be operable to communicate with one or more devices related to an experience provider to transmit tag information and/or receive managed user experiences.

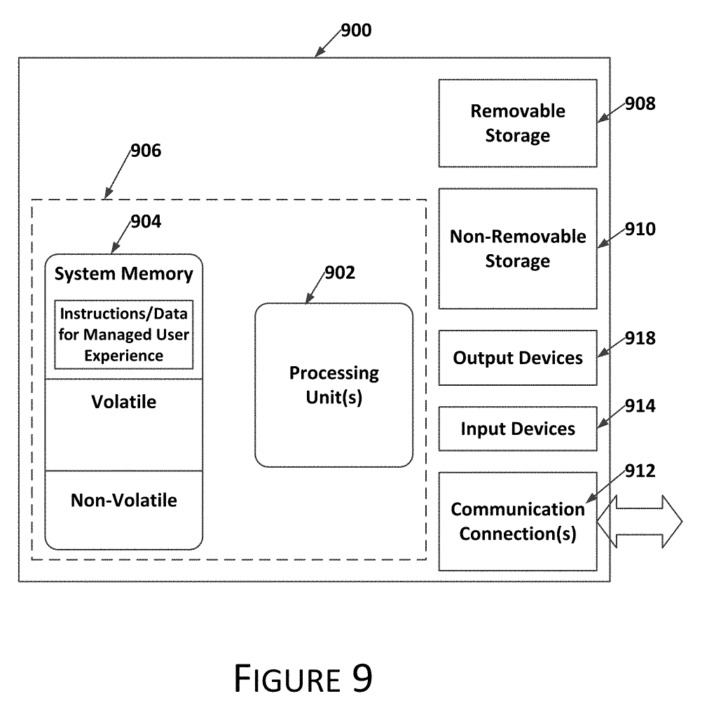

FIG. 9 illustrates yet another example of a suitable operating environment 900 in which one or more of the present embodiments may be implemented. This is only one example of a suitable operating environment and is not intended to suggest any limitation as to the scope of use or functionality. Other well-known computing systems, environments, and/or configurations that may be suitable for use include, but are not limited to, personal computers, server computers, hand-held or laptop devices, multiprocessor systems, microprocessor-based systems, programmable consumer electronics such as smart phones, network PCs, minicomputers, mainframe computers, distributed computing environments that include any of the above systems or devices, and the like.

In its most basic configuration, operating environment 900 typically includes at least one processing unit 902 and memory 904. Depending on the exact configuration and type of computing device, memory 904 (instructions to perform the managed user experience operations disclosed herein) may be volatile (such as RAM), non-volatile (such as ROM, flash memory, etc.), or some combination of the two. This most basic configuration is illustrated in FIG. 9 by dashed line 906. Further, environment 900 may also include storage devices (removable, 908, and/or non-removable, 910) including, but not limited to, magnetic or optical disks or tape. Similarly, environment 900 may also have input device(s) 914 such as keyboard, mouse, pen, voice input, etc. and/or output device(s) 916 such as a display, speakers, printer, etc. Also included in the environment may be one or more communication connections, 912, such as LAN, WAN, point to point, etc.

Operating environment 900 typically includes at least some form of computer readable media. Computer readable media can be any available media that can be accessed by processing unit 902 or other devices comprising the operating environment. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other tangible, non-transitory medium which can be used to store the desired information. Computer storage media does not include communication media.

Communication media embodies computer readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

The operating environment 900 may be a single computer operating in a networked environment using logical connections to one or more remote computers. The remote computer may be a personal computer, a server, a router, a network PC, a peer device or other common network node, and typically includes many or all of the elements described above as well as others not so mentioned. The logical connections may include any method supported by available communications media. Such networking environments are commonplace in offices, enterprise-wide computer networks, intranets and the Internet.

As will be understood from the foregoing disclosure, one aspect of the technology relates to a tag for interfacing with a consumer product. The tag comprises: at least one processor; a communication unit; a consumer product interface; and memory encoding computer executable instructions that, when executed by the at least one processor, perform a method. The method comprises: receiving, via the consumer product interface, identification information associated with the consumer product; providing the identification information to an experience provider using the communication unit; receiving, via the communication unit, a managed user experience associated with the identification information; and providing at least a subpart of the managed user experience to the consumer product using the consumer product interface. In an example, providing the identification information to the experience provider using the communication unit comprises communicating with a base station associated with the tag. In another example, communicating with the base station comprises communicating with an intermediary device, wherein the intermediary device is a relay between the tag and the base station. In a further example, the memory comprises tag identification information associated with the tag. In yet another example, providing the identification information further comprises providing the tag identification information. In a further still example, the managed experience comprises a set of instructions, and wherein the method further comprises providing the set of instructions to the consumer product using the consumer product interface. In another example, the method further comprises: receiving, using the consumer product interface, sensor information from a sensor of the consumer product.

In another aspect, the technology relates to a system comprising: at least one processor; and memory encoding computer executable instructions that, when executed by the at least one processor, perform a method. The method comprises: detecting a tag associated with a consumer product; receiving identification information for the consumer product from the tag; retrieving a managed user experience for the consumer product based on the identification information; determining, based at least upon the managed user experience, whether a first set of operations are to be performed by the consumer product; when the first set of operations is to be performed by the consumer product, transmitting the first set of operations to the tag; and performing one or more additional operations in accordance with the managed user experience. In an example, the retrieved managed user experience comprises content associated with the consumer product. In another example, the method further comprises: transmitting at least a part of the content to the tag to be provided to the consumer product. In a further example, the received identification information further comprises identification information associated with the tag, and retrieving the managed user experience is further based on the identification information associated with the tag. In yet another example, the method further comprises: detecting that the tag is associated with a second consumer product; receiving, from the tag, different identification information associated with the second consumer product; and retrieving a second managed user experience for the second consumer product based on the different identification information. In a further still example, the method further comprises: determining, based on the managed user experience, to request sensor information from the consumer product; based on determining to request sensor information, providing a request to the tag for sensor information from the consumer product; and receiving sensor information from the tag.

In a further aspect, the technology relates to a computer-implemented method for interacting with a consumer product by a tag. The method comprises: determining identification information for the consumer product; providing the determined identification information to an experience provider; receiving, from the experience provider, a managed user experience; determining, based on the managed user experience, whether to provide content to the consumer product; and when it is determined to provide the content, communicating the content to a processor of the consumer product. In an example, the method further comprises: determining, based on the managed user experience, whether to provide a set of instructions to the consumer product; and when it is determined to provide the set of processing instructions, communicating the set of processing instructions to a processor of the consumer product. In another example, the method further comprises: determining, based on the managed user experience, whether to request sensor information from the consumer product; when it is determined to request sensor information, communicating a request for sensor information to the consumer product; receiving sensor information from the consumer product; and providing at least a subset of the received sensor information to the experience provider. In a further example, the method further comprises: determining a second consumer product is connected to a consumer product interface; determining different identification information for the consumer product; and receiving a second managed user experience from an experience provider based on the different identification information. In yet another example, the first managed user experience and the second managed user experience are associated with a user, and wherein the user is associated with tag identification information from the tag. In a further still example, the managed user experience is received indirectly via at least one of a base station and an intermediary device. In an example, the method further comprises; communicating at least a part of the managed user experience to a device other than the consumer product.

Aspects of the present disclosure, for example, are described above with reference to block diagrams and/or operational illustrations of methods, systems, and computer program products according to aspects of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

The description and illustration of one or more aspects provided in this application are not intended to limit or restrict the scope of the disclosure as claimed in any way. The aspects, examples, and details provided in this application are considered sufficient to convey possession and enable others to make and use the best mode of claimed disclosure. The claimed disclosure should not be construed as being limited to any aspect, example, or detail provided in this application. Regardless of whether shown and described in combination or separately, the various features (both structural and methodological) are intended to be selectively included or omitted to produce an embodiment with a particular set of features. Having been provided with the description and illustration of the present application, one skilled in the art may envision variations, modifications, and alternate aspects falling within the spirit of the broader aspects of the general inventive concept embodied in this application that do not depart from the broader scope of the claimed disclosure.

What is claimed is:

1. A tag for interfacing with a consumer product, comprising:
at least one processor;
a communication unit;
a consumer product interface; and
memory encoding computer executable instructions that, when executed by the at least one processor, perform a method comprising:
receiving, via the consumer product interface, identification information associated with the consumer product;
providing the identification information to an experience provider using the communication unit;
receiving, via the communication unit, a managed user experience associated with the identification information; and
providing at least a subpart of the managed user experience to the consumer product using the consumer product interface.

2. The tag of claim 1, wherein providing the identification information to the experience provider using the communication unit comprises communicating with a base station associated with the tag.

3. The tag of claim 2, wherein communicating with the base station comprises communicating with an intermediary device, wherein the intermediary device is a relay between the tag and the base station.

4. The tag of claim 1, wherein the memory comprises tag identification information associated with the tag.

5. The tag of claim 4, wherein providing the identification information further comprises providing the tag identification information.

6. The tag of claim 1, wherein the managed experience comprises a set of instructions, and wherein the method further comprises providing the set of instructions to the consumer product using the consumer product interface.

7. The tag of claim 1, wherein the method further comprises:
receiving, using the consumer product interface, sensor information from a sensor of the consumer product.

8. A system comprising:
at least one processor; and
memory encoding computer executable instructions that, when executed by the at least one processor, perform a method comprising:
detecting a tag associated with a consumer product;
receiving identification information for the consumer product from the tag;
retrieving a managed user experience for the consumer product based on the identification information;
determining, based at least upon the managed user experience, whether a first set of operations are to be performed by the consumer product;
when the first set of operations is to be performed by the consumer product, transmitting the first set of operations to the tag; and
performing one or more additional operations in accordance with the managed user experience.

9. The system of claim 8, wherein the retrieved managed user experience comprises content associated with the consumer product.

10. The system of claim 9, wherein the method further comprises:
transmitting at least a part of the content to the tag to be provided to the consumer product.

11. The system of claim 8, wherein the received identification information further comprises identification information associated with the tag, and retrieving the managed user experience is further based on the identification information associated with the tag.

12. The system of claim 8, wherein the method further comprises:
detecting that the tag is associated with a second consumer product;
receiving, from the tag, different identification information associated with the second consumer product; and
retrieving a second managed user experience for the second consumer product based on the different identification information.

13. The system of claim 8, wherein the method further comprises:
determining, based on the managed user experience, to request sensor information from the consumer product;
based on determining to request sensor information, providing a request to the tag for sensor information from the consumer product; and
receiving sensor information from the tag.

14. A computer-implemented method for interacting with a consumer product by a tag, comprising:
determining identification information for the consumer product;
providing the determined identification information to an experience provider;
receiving, from the experience provider, a managed user experience;
determining, based on the managed user experience, whether to provide content to the consumer product; and
when it is determined to provide the content, communicating the content to a processor of the consumer product.

15. The computer-implemented method of claim 14, further comprising:
determining, based on the managed user experience, whether to provide a set of instructions to the consumer product; and
when it is determined to provide the set of processing instructions, communicating the set of processing instructions to a processor of the consumer product.

16. The computer-implemented method of claim 14, further comprising:
determining, based on the managed user experience, whether to request sensor information from the consumer product;
when it is determined to request sensor information, communicating a request for sensor information to the consumer product;
receiving sensor information from the consumer product; and
providing at least a subset of the received sensor information to the experience provider.

17. The computer-implemented method of claim 14, further comprising:
determining a second consumer product is connected to a consumer product interface;
determining different identification information for the consumer product; and
receiving a second managed user experience from an experience provider based on the different identification information.

18. The computer-implemented method of claim 17, wherein the first managed user experience and the second managed user experience are associated with a user, and wherein the user is associated with tag identification information from the tag.

19. The computer-implemented method of claim 14, wherein the managed user experience is received indirectly via at least one of a base station and an intermediary device.

20. The computer-implemented method of claim 14, further comprising:
communicating at least a part of the managed user experience to a device other than the consumer product.
